(19) United States
(12) Patent Application Publication
(10) Pub. No.: US 2007/0146955 A1
(43) Pub. Date: Jun. 28, 2007

(54) Semiconductor integrated circuit device

(76) Inventors: Yoshikazu Makabe, Osaka (JP); Makoto Yamamoto, Osaka (JP)

Correspondence Address: MCDERMOTT WILL & EMERY LLP, 600 13TH STREET, N.W., WASHINGTON, DC, 20005-3096, US

(21) Appl. No.: 11/645,767

(22) Filed: Dec. 27, 2006

(30) Foreign Application Priority Data
Dec. 27, 2005 (JP) 2005-374447

(51) Int. Cl. H02H 9/06

(52) U.S. Cl. 361/118

(57) ABSTRACT

A semiconductor integrated circuit device has an internal circuit connected to each of an external terminal, a high-potential power source terminal, and a low-potential power source terminal, a surge protection circuit connected between the external terminal and the low-potential power source terminal to protect the internal circuit from a surge voltage applied to the external terminal, a capacitor having one terminal connected to the external terminal, a transistor connected between the other terminal of the capacitor and the low-potential power source terminal, and a control circuit which brings the internal circuit into a stopped state and does not activate the transistor when the surge voltage is applied to the external terminal.

### CROSS-REFERENCE TO RELATED APPLICATIONS

The teachings of Japanese Patent Application JP 2005-374447, filed Dec. 27, 2005, are entirely incorporated herein by reference, inclusive of the claims, specification, and drawings.

### BACKGROUND OF THE INVENTION

The present invention relates to a semiconductor integrated circuit device having a surge protection circuit for preventing the electrostatic breakdown of an electronic function circuit.

FIG. 8 shows an example of a structure of a semiconductor integrated circuit device having a surge protection circuit according to a first conventional embodiment. As shown in FIG. 8, an internal circuit 1 is connected to an external terminal 2, to a control terminal 210 for controlling an operating state of the internal circuit 1, a high-potential power source terminal 3, and a low-potential power-source terminal 4. A surge protection circuit 6 is connected between the external terminal 2 and the low-potential power source terminal 4. The surge protection circuit 6 is comprised of a transistor having a collector connected to the external terminal 2 and an emitter connected to the low-potential power source terminal 4. A first resistor 5 is connected between the base and emitter of the transistor.

A capacitor 7 for lowering an RF impedance and a second resistor 80 for improving the surge breakdown voltage of the capacitor 7 are connected between the external terminal 2 and the low-potential power source terminal 4.

The internal circuit 1 connected to the external terminal 2 is an input buffer circuit having an output terminal 16 and is comprised of transistors 11 to 15 and constant current sources 17 and 18. When a LOW-level voltage is inputted from the control terminal 210 to the gate electrode of each of two MOS (metal-oxide-semiconductor) transistors 19 and 20, currents from the constant current sources 17 and 18 are shut down.

Next, a description will be given to the operation of the surge protection circuit 6 shown in FIG. 8.

When the voltage applied to the external terminal 2 is lower than the operating voltage of the internal circuit 1, the surge protection circuit 6 is in a cut-off and high-impedance state. Accordingly, the surge protection circuit 6 does not perform any operation and the voltage applied to the external terminal 2 is supplied as it is to the internal circuit 1 and normal signal processing is performed in the internal circuit 1. At this time, since the capacitor 7 lowers the RF impedance, the influence of RF noise can be reduced.

When a surge voltage is applied to the external terminal by any cause, the surge protection circuit 6 breaks down when a voltage BV_{CER} (collector-emitter breakdown voltage when a resistor is connected between a base and an emitter) is exceeded. By thus limiting the voltage applied to the external terminal 2 using the surge protection circuit 6, it is possible to protect the internal circuit 1 from static electricity (surge).

In the semiconductor integrated circuit device shown in FIG. 8, when the breakdown voltage of the capacitor 7 becomes lower than the breakdown voltage of the surge protection circuit 6 due to variations in the breakdown voltage of the surge protection circuit 6, the capacitor 7 undesirably breaks down. Therefore, to prevent the breakdown of the capacitor 7, the second resistor 80 has been inserted between the external terminal 2 and the capacitor 7.

Next, a description will be given next to a semiconductor integrated circuit device having a surge protection circuit according to a second conventional embodiment (see, e.g., Japanese Laid-Open Patent Publication No. HEI 9-162303).

FIG. 9 shows a structure of the semiconductor integrated circuit device having the surge protection circuit disclosed in the publication mentioned above. As shown in FIG. 9, an external terminal 200 is connected to the internal circuit 1. A first diode 90 for discharging positive charge is connected between the external terminal 200 and the high-potential power source terminal 3. A second diode element 91 for discharging negative charge is connected between the external terminal 200 and the low-potential power source terminal 4. A surge protection circuit comprised of a transistor 112 and a resistor 113 is connected to the high-potential power source terminal 3.

In addition, the capacitor 7 for lowering the RF impedance is connected to the external terminal 200. A MOS transistor 110 is connected between the capacitor 7 and the low-potential power source terminal 4. A MOS transistor 110 has a drain connected to the capacitor 7, a source connected to the low-potential power source terminal 4, and a gate connected to the high-potential power source terminal 3.

A description will be given to the operation of the surge protection circuit comprised of the transistor 112 and the resistor 113.

When the voltage applied to the external terminal 200 is lower than the power source voltage, each of the diodes 90 and 91 is in a cut-off and high-impedance state. Accordingly, the surge protection circuit comprised of the transistor 112 and the resistor 113 does not perform any operation and the voltage applied to the external terminal 200 is supplied as it is to the internal circuit 1 and normal signal processing is performed. At this time, when the power source of the semiconductor integrated circuit is turned ON, the MOS transistor 100 is also turned ON and the terminal of the capacitor 7 which is connected to the low-potential power source terminal 4 shifts to a low potential (ground potential) so that the RF impedance lowers to reduce the influence of the RF noise.

On the other hand, when a positive surge voltage exceeding the power source voltage is applied to the external terminal 200 by any cause, the first diode element 90 is brought into conduction to clamp the voltage applied to the external terminal 200. At this time, the surge protection circuit comprised of the transistor 112 and the resistor 113 discharges the surge voltage.

Conversely, when a negative surge voltage exceeding the power source voltage is applied to the external terminal 200, the second diode element 91 is brought into conduction to clamp the voltage applied to the external terminal 200. When the potential at the high-potential power source terminal 3 has not risen to a specified power source potential, the MOS transistor 110 is turned OFF. This increases the breakdown voltage of the capacitor 7 and allows the prevention of the breakdown of the capacitor 7 due to the voltage applied to the capacitor 7.

However, each of the semiconductor integrated circuit devices having the surge protection circuits according to the first and second conventional embodiments described above has the following problems.

In the semiconductor integrated circuit device according to the first conventional embodiment shown in FIG. 8, the second resistor 80 is provided between the external terminal 2 and the capacitor 7, assuming the case where the breakdown voltage of the surge protection circuit 6 becomes higher than the breakdown voltage of the capacitor 7 due to variations in the breakdown voltage of the surge protection circuit 6. However, the provision of the second resistor 80 causes the problem that the RF impedance during the operation rises and is more susceptible to the influence of the RF noise.

In the surge protection circuit comprised of the transistor 112 and the resistor 113 of the semiconductor integrated circuit device according to the second conventional embodiment shown in FIG. 9, when a positive surge voltage exceeding the power source voltage is applied to the external terminal 200, the potential at the high-potential power source terminal 3 may rise to turn ON the MOS transistor 110 even when the power source has not been turned ON. At this time, the problem occurs that a voltage not less than the breakdown voltage of the capacitor 7 is applied thereto and causes the breakdown of the capacitor 7.

Against such a background, there has been a growing demand for a protection circuit which prevents the breakdown of an internal circuit due to a surge and protects a capacitor for improving the characteristics of a semiconductor integrated circuit device from breakdown due to the surge without being affected by variations in the breakdown voltage of the surge protection circuit.

### SUMMARY OF THE INVENTION

It is therefore an object of the present invention to solve the conventional problems described above and thereby prevent the breakdown of an internal circuit due to a surge voltage, while allowing the protection of a capacitor for improving the characteristics of a semiconductor integrated circuit device from breakdown due to the surge without being affected by variations in the breakdown voltage of a surge protection circuit.

To attain the above-mentioned object, the present invention constitutes a semiconductor integrated circuit device such that, when a surge voltage is applied from the outside thereof, an internal circuit and a transistor for protecting a capacitor for improving the characteristics are kept from operating or the operation of the transistor for protecting the capacitor is delayed from the time at which the surge voltage is applied.

Specifically, a first semiconductor integrated circuit device according to the present invention comprises: an internal circuit connected to each of an external terminal, a high-potential power source terminal, and a low-potential power source terminal; a surge protection circuit connected between the external terminal and the low-potential power source terminal to protect the internal circuit from a surge voltage applied to the external terminal; a capacitor having one terminal connected to the external terminal; a transistor connected between the other terminal of the capacitor and the low-potential power source terminal; and a control circuit which brings the internal circuit into a stopped state and does not activate the transistor when the surge voltage is applied to the external terminal.

In the first semiconductor integrated circuit device, when a surge voltage exceeding the power source voltage is applied, even though the potential at the high-potential power source terminal rises to a level not less than the power source voltage, the transistor is not turned ON. This prevents a voltage not less than the breakdown voltage of the capacitor from being applied thereto and thereby prevents the breakdown of the capacitor. In addition, since a resistor connected in series to the capacitor for preventing the influence of variations in the breakdown voltage of the surge protection circuit is no more necessary, it is possible to prevent a rise in RF impedance during the operation.

In the first semiconductor integrated circuit device, the surge protection circuit preferably comprises: a bipolar transistor having a collector connected to the external terminal and an emitter connected to the low-potential power source terminal; and a first resistor having one terminal connected to a base of the bipolar transistor and the other terminal connected to the emitter.

In the first semiconductor integrated circuit device, the surge protection circuit preferably comprises: a first field-effect transistor having a drain connected to the external terminal and a source connected to the low-potential power source terminal; and a first resistor having one terminal connected to a gate of the first field-effect transistor and the other terminal connected to the source.

In the first semiconductor integrated circuit device, the transistor is preferably a second field-effect transistor having a drain connected to the other terminal of the capacitor, a source connected to the low-potential power source terminal, and a gate connected to the low-potential power source terminal with a second resistor interposed therebetween.

In this case, the control circuit is preferably connected to the gate of the second field-effect transistor.

A second semiconductor integrated circuit device according to the present invention comprises: an internal circuit connected to each of an external terminal, a high-potential power source terminal, and a low-potential power source terminal; a surge protection circuit connected between the external terminal and the low-potential power source terminal to protect the internal circuit from a surge voltage applied to the external terminal; a first capacitor having one terminal connected to the external terminal; a transistor connected between the other terminal of the first capacitor and the low-potential power source terminal; and a delay circuit which activates, when the surge voltage is applied to the external terminal, the transistor after a specified time has elapsed from the application of the surge voltage.

In the second semiconductor integrated circuit device, when a surge voltage exceeding the power source voltage is applied, even though the potential at the high-potential power source terminal rises to a level not less than the power source voltage, the transistor is not turned ON. This prevents a voltage not less than the breakdown voltage of the capacitor from being applied thereto and thereby prevents the breakdown of the capacitor. In addition, since a resistor connected in series to the capacitor for preventing the influence of variations in the breakdown voltage of the surge protection circuit is no more necessary, it is possible to prevent a rise in RF impedance during the operation.

In the second semiconductor integrated circuit device, the surge protection circuit preferably comprises: a bipolar transistor having a collector connected to the external terminal and an emitter connected to the low-potential power source terminal; and a first resistor having one terminal connected to a base of the bipolar transistor and the other terminal connected to the emitter.

In the second semiconductor integrated circuit device, the surge protection circuit preferably comprises: a first field-effect transistor having a drain connected to the external terminal and a source connected to the low-potential power source terminal; and a first resistor having one terminal connected to a gate of the first field-effect transistor and the other terminal connected to the source.

In the second semiconductor integrated circuit device, the transistor is preferably a second field-effect transistor having a drain connected to the other terminal of the first capacitor, a source connected to the low-potential power source terminal, and a gate connected to the low-potential power source terminal with a second resistor interposed therebetween.

In this case, the delay circuit is preferably a low-pass filter including a third resistor connected between the high-potential power source terminal and the gate of the second field-effect transistor and a second capacitor connected between the gate of the second field-effect transistor and the low-potential power source terminal.

### BRIEF DESCRIPTION OF THE DRAWINGS

FIG. 1 is a circuit diagram showing an example of a semiconductor integrated circuit device according to a first embodiment of the present invention;

FIG. 2 is a graph showing the breakdown voltage characteristic of a surge protection circuit in the semiconductor integrated circuit device according to the first embodiment;

FIG. 3 is a circuit diagram showing an example of a control circuit in the semiconductor integrated circuit device according to the first embodiment

FIG. 4 is a circuit diagram showing a semiconductor integrated circuit device according to a variation of the first embodiment of the present invention;

FIG. 5 is a circuit diagram showing an example of a semiconductor integrated circuit device according to a second embodiment of the present invention;

FIG. 6 is a graph showing the relationship between the gate voltage of a MOS transistor and an elapsed time during the application of a surge voltage in the semiconductor integrated circuit device according to the second embodiment in comparison with that in a semiconductor integrated circuit device according to a second conventional embodiment;

FIG. 7 is a circuit diagram showing a semiconductor integrated circuit device according to a variation of the second embodiment of the present invention;

FIG. 8 is a circuit diagram showing a semiconductor integrated circuit device according to a first conventional embodiment; and

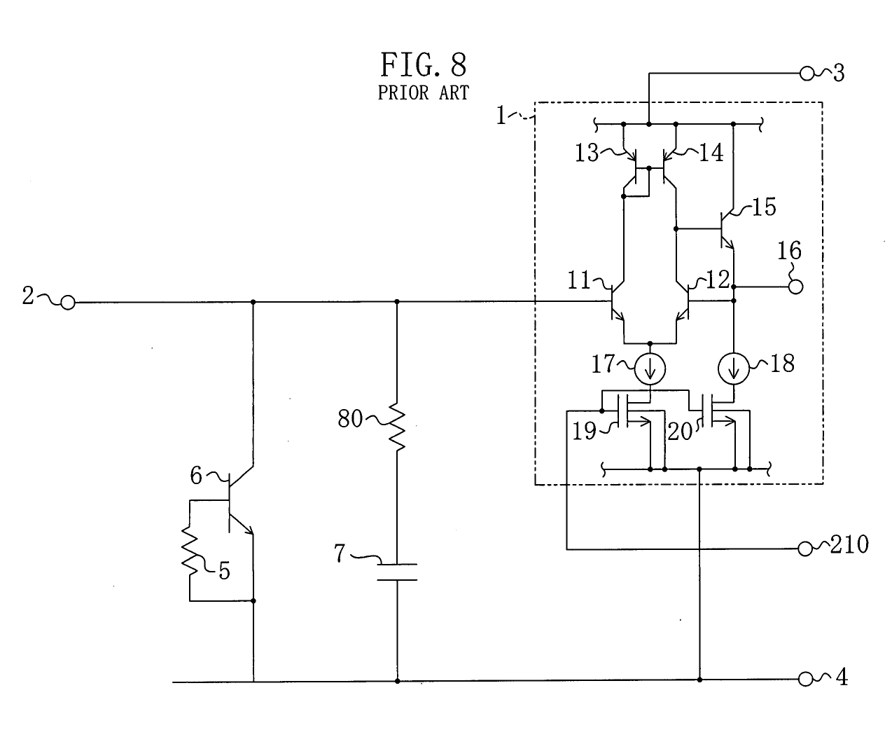

FIG. 9 is a circuit diagram showing the semiconductor integrated circuit device according to the second conventional embodiment.

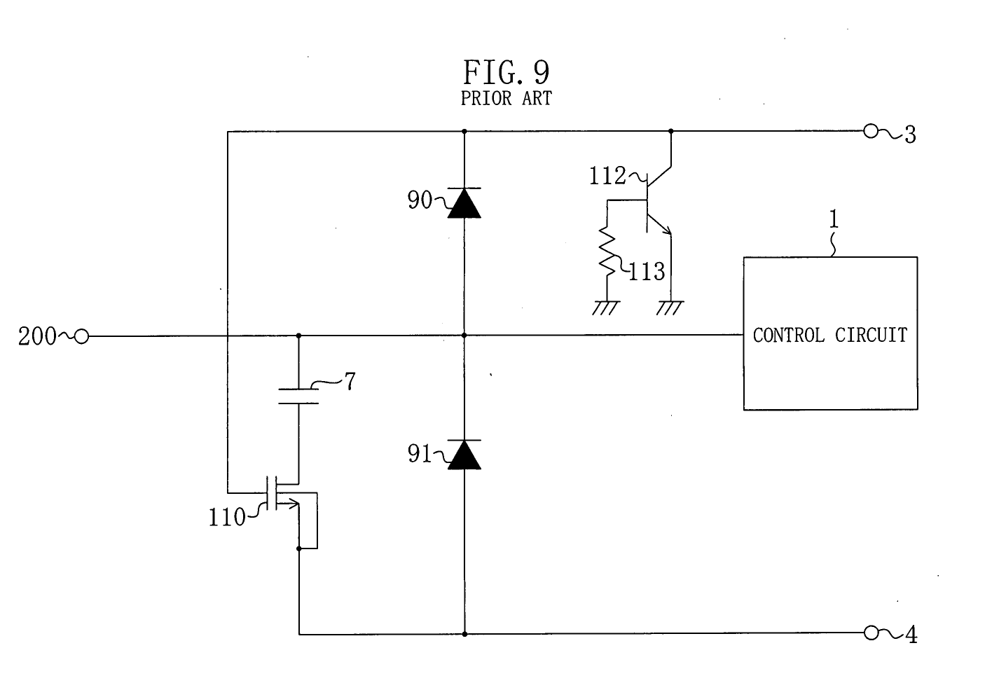

### DESCRIPTION OF THE PREFERRED EMBODIMENTS

### Embodiment 1

A first embodiment of the present invention will be described with reference to the drawings.

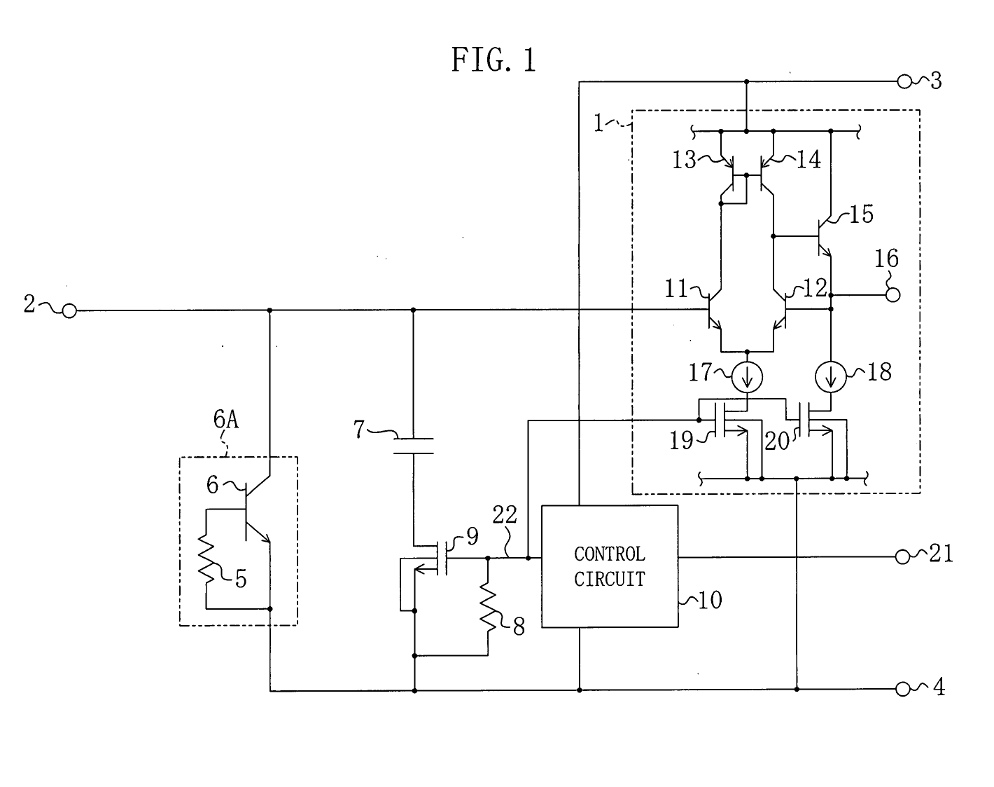

FIG. 1 shows a circuit structure of a semiconductor integrated circuit device according to the first embodiment. As shown in FIG. 1, an internal circuit 1 is a buffer circuit having an emitter follower structure. The internal circuit 1 has: a first NPN-type transistor (bipolar transistor) 11 having a base connected to a first external terminal 2 and an emitter connected to a first constant current source 17; a second NPN-type transistor 12 having a base connected to each of an output terminal 16 and a second constant current source 18 and an emitter connected to the first constant current source 17; a first PNP-type transistor 13 having an emitter connected to a high-potential power source terminal 3 and a base connected to a collector thereof; a second PNP-type transistor 14 having an emitter connected to the high-potential power source terminal 3, a base used commonly as the base of the first PNP-type transistor 13, and a collector connected to the collector of the second NPN-type transistor 12; a third NPN-type transistor 15 having a collector connected to the high-potential power source terminal 3, a base connected to the collector of the second PNP-type transistor 14, and an emitter connected to each of the output terminal 16 and the second constant current source 18; a first N-type MOS transistor (NMOS-type field-effect transistor) 19 having a drain connected to the first constant current source 17, a source connected to a low-potential power source terminal 4, and a gate connected to a control signal line 22; and a second N-type MOS transistor 20 having a drain connected to the second constant current source 18, a source connected to the low-potential power source terminal 4, and a gate connected to the control signal line 22.

A surge protection circuit 6A for discharging charge resulting from a surge is connected between the first external terminal 12 and the low-potential power source terminal 4. The surge protection circuit 6A is comprised of: a fourth NPN-type transistor 6 having a collector connected to the first external terminal 2 and an emitter connected to the low-potential power source terminal 4; and a first resistor 5 having one terminal connected to the base of the fourth NPN-type transistor 6 and the other terminal connected to the emitter thereof.

A capacitor 7 for improving the RF characteristics of the integrated circuit device according to the present embodiment and a third N-type MOS transistor 9 as a switch for switching the breakdown voltage of the capacitor 7 are connected in series between the first external terminal 2 and the low-potential power source terminal 4. The third N-type MOS transistor 9 has a drain connected to the capacitor 7 and a source connected the low-potential power source terminal 4. A second resistor 8 is connected between the gate and source of the third N-type MOS transistor 9.

The semiconductor integrated circuit device according to the first embodiment is characterized in that it has a control circuit 10 connected to each of the high-potential power source terminal 3, the low-potential power source terminal 4, and a second external terminal 21. The control circuit 10 is controlled by a control signal applied to the second external terminal 21 and applies the control signal to the gate of each of the MOS transistors 9, 19, and 20 via the control signal line 22.

Next, a description will be given to the operation of the semiconductor integrated circuit device according to the first embodiment.

First, when the voltage applied to the first external terminal 2 is lower than the operating voltage of the internal circuit 1, the fourth NPN-type transistor 6 is in a cut-off state so that the surge protection circuit 6A is in a high-impedance state. Accordingly, the surge protection circuit 6A does not perform any operation and the voltage applied to the first external terminal 2 is supplied as it is to the internal circuit 1 and normal signal processing is performed. At this time, the control circuit 10 is controlled by the control signal applied to the second external terminal 21. The control circuit 10 supplies a HIGH-level voltage via the control signal line 22 to bring each of the first and second N-type MOS transistors 19 and 20 into conduction, thereby bringing the internal circuit 1 into an operating state. At the same time, the third N-type MOS transistor 9 is also turned ON so that the input impedance of the MOS transistor 9 lowers.

When a surge voltage is applied to the first external terminal 2 by any cause, the surge protection circuit 6 breaks down when a voltage VB_{CER} (collector-emitter breakdown voltage when a resistor is connected between a base and an emitter) is exceeded. At this time, the control circuit 10 is controlled by the second external terminal 21. Specifically, the control circuit 10 supplies a LOW-level voltage via the control signal line 22 to turn OFF each of the first and second first N-type MOS transistors 19 and 20, thereby bringing the internal circuit 1 into a non-operating state. At this time, the third N-type MOS transistor 9 is also turned OFF.

It is assumed herein that the breakdown voltage of the capacitor 7 is VBc, the breakdown voltage of the third N-type MOS transistor 9 is BV_{M} and the breakdown voltage of the surge protection circuit 6 is BV_{T}. Provided that the relationship represented by the numerical expression (1) is satisfied, the surge protection circuit 6 breaks down before the capacitor 7 breaks down and therefore the breakdown of the capacitor 7 can be prevented:
BV_{C}+BV_{M}≧BV_{T} (1).

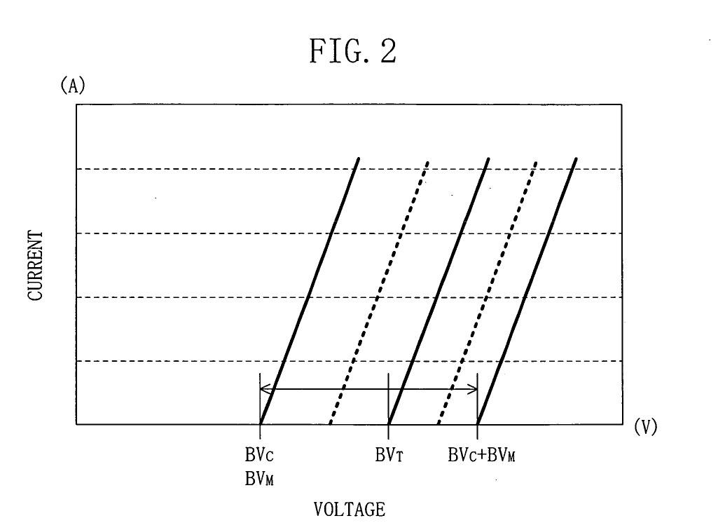

FIG. 2 shows the breakdown characteristic of the surge protection circuit 6A. As shown in FIG. 2, the semiconductor integrated circuit device according to the first embodiment can limit the surge voltage applied to the first external terminal 2 by using the surge protection circuit 6 and thereby protect the internal circuit 1 from breakdown due to the surge voltage within the range which satisfies the relationship given by the numerical expression (1).

The control circuit 10 is controlled from the second external terminal 21 independently of the value of the power source voltage and the ON/OFF state of the third N-type MOS transistor 9 is controlled via the control signal line 22 of the control circuit 10. Accordingly, even when the voltage at the high-potential power source terminal 3 is increased by the surge voltage applied to the first external terminal 2, the third N-type MOS transistor 9 is not automatically turned ON and therefore the breakdown voltage of the capacitor 7 can be increased. That is, even when a voltage higher than the breakdown voltage of the surge protection circuit 6 is applied to the capacitor 7, the breakdown of the capacitor 7 can be prevented with the total sum of the breakdown voltage of the capacitor 7 and the breakdown voltage of the third N-type MOS transistor 9.

In addition, the control circuit 10 can , reliably protect the internal circuit 1 from a surge by also controlling the operating state of the internal circuit 1.

During the normal operation of the semiconductor integrated circuit device, the control circuit 10 is brought into an operating state under control from the second external terminal 21 and the third N-type MOS transistor 9 is turned ON. At this time, the input impedance of the third N-type MOS transistor 9 lowers and the capacitor 7 can achieve improvements in the RF characteristics of the semiconductor integrated circuit device, which are an intrinsic object.

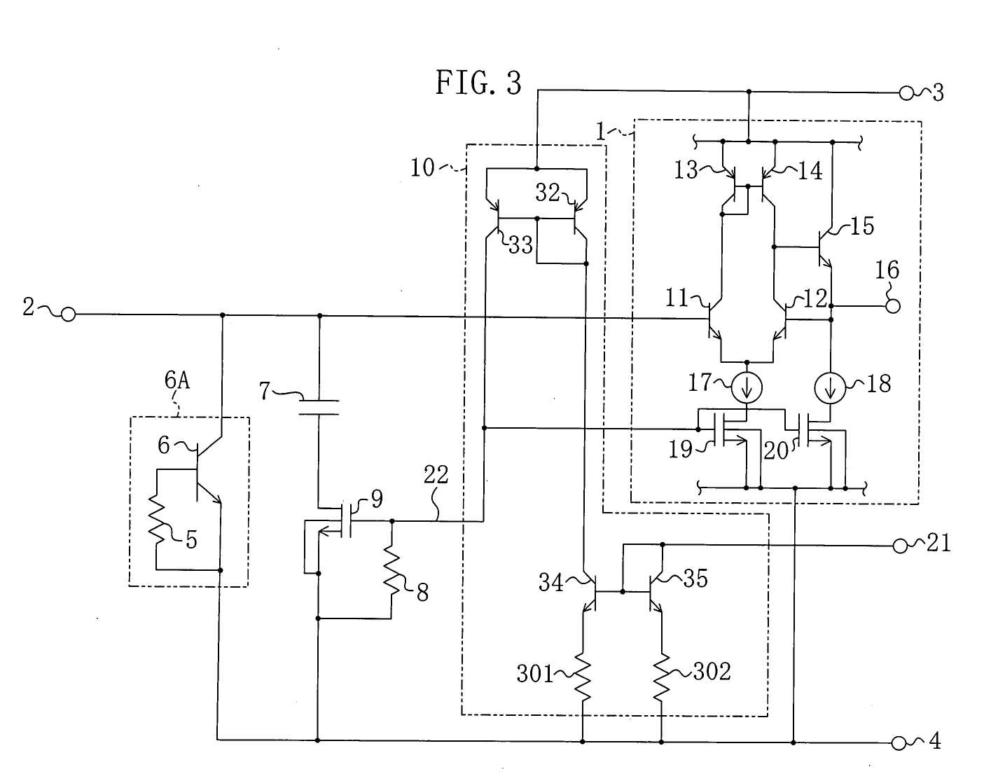

FIG. 3 shown an example of a structure of the control circuit 10. As shown in FIG. 3, the control circuit 10 has: a third PNP-type transistor 32 having an emitter connected to the high-potential power source terminal 3 and a base connected to a collector thereof; a fourth PNP-type transistor 33 having an emitter connected to the high-potential power source terminal 3, a base used commonly as the base of the third PNP-type transistor 32, and a collector connected to the control signal line 22; a fifth NPN-type transistor 34 having a collector connected to the collector of the third PNP-type transistor 32 and an emitter connected to one terminal of a third resistor 301; and a sixth NPN-type transistor 35 having a collector and a base each connected to the second external terminal 21, of which the base is used commonly as the base of the fifth NPN-type transistor 34, and an emitter connected to one terminal of a fourth resistor 302. Each of the third and fourth resistors 301 and 302 has the other terminal connected to the low-potential power source terminal 4.

Next, a description will be given to the operation of the control circuit 10 shown in FIG. 3.

When a voltage of 5 V is applied to the second external terminal 21, the control circuit 10 applies a voltage of 5 V to the base used commonly between the fifth and sixth NPN-type transistors 34 and 35. As a result, each of the fifth and sixth NPN-type transistors 34 and 35 is turned ON, while each of the third and fourth PNP-type transistors 32 and 33 is also turned ON simultaneously, so that the control circuit 10 is brought into an operating state. When the fourth PNP-type transistor 33 is turned ON, the potential at the control signal line 22 shifts to a high potential so that each of the first and second N-type MOS transistors 19 and 20 is turned ON to bring the internal circuit 1 into an operating state. At the same time, the high potential on the control signal line 22 turns ON the third N-type MOS transistor 9.

By contrast, when a voltage of 0 V is applied to the second external terminal 21, each of the fifth and sixth NPN-type transistors 34 and 35 and the third and fourth PNP-type transistors 32 and 33 is turned OFF in the control circuit 10 so that the control circuit 10 is brought into a non-operating state. At the same time, the potential on the control signal line 22 also becomes a low potential (0 V) so that the third N-type MOS transistor 9 is turned OFF and each of the first and second N-type MOS transistors 19 and 20 is turned OFF so that the internal circuit 1 is brought into a non-operating state.

### Variation of Embodiment 1

A variation of the first embodiment of the present invention will be described herein below with reference to the drawings.

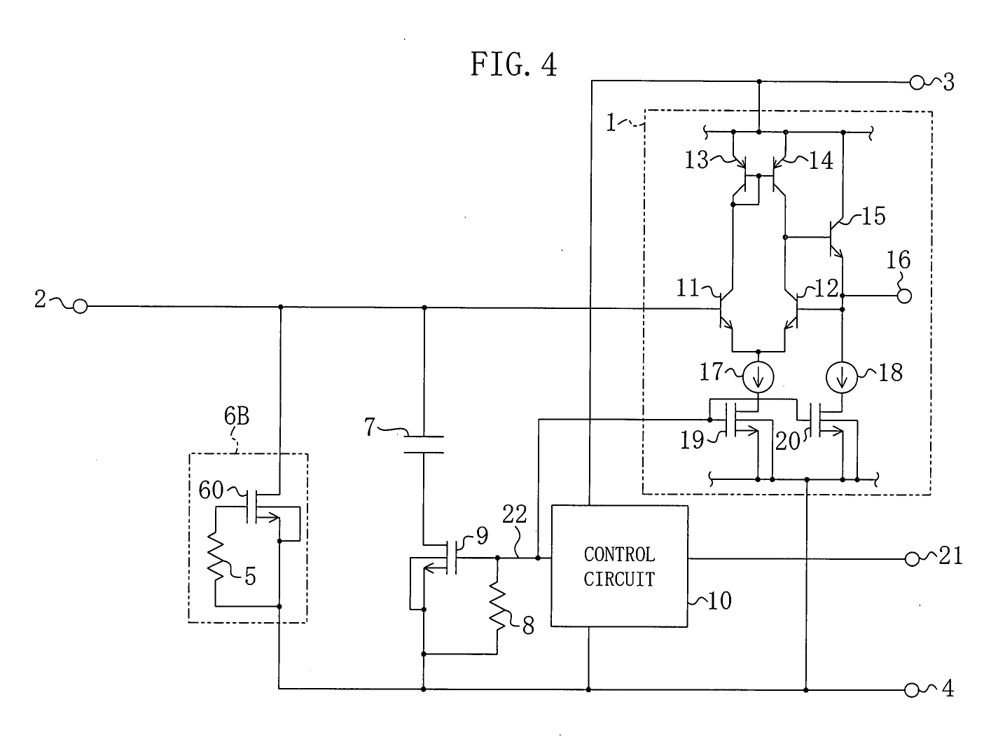

FIG. 4 shows a circuit structure of a semiconductor integrated circuit device according to the variation of the first embodiment. The description of the components shown in FIG. 4 which are the same as shown in FIG. 1 will be omitted by retaining the same reference numerals.

As shown in FIG. 4, the present variation is different from the first embodiment in that a surge protection circuit 6B has a fourth N-type MOS transistor 60 in place of the fourth NPN-type transistor 6. Specifically, the surge protection circuit 6B is comprised of the fourth N-type MOS transistor 60 having a drain connected to the first external terminal 2 and the source connected to the low-potential power source terminal 4; and the first resistor 5 having one terminal connected to the gate of the fourth N-type MOS transistor and the other terminal connected to the source thereof.

Since the surge protection circuit 6B has the MOS transistor in place of the bipolar transistor, the breakdown voltage (BV_{M}) of the third N-type MOS transistor 9 is equal to the breakdown voltage (BV_{T}) of the surge protection circuit 6B so that the relationship represented by the numerical expression (1) shown above is necessarily satisfied. This allows reliable protection of the capacitor 7 for improving the RF characteristics from breakdown due to the surge.

### Embodiment 2

A second embodiment of the present invention will be described herein below with reference to the drawings.

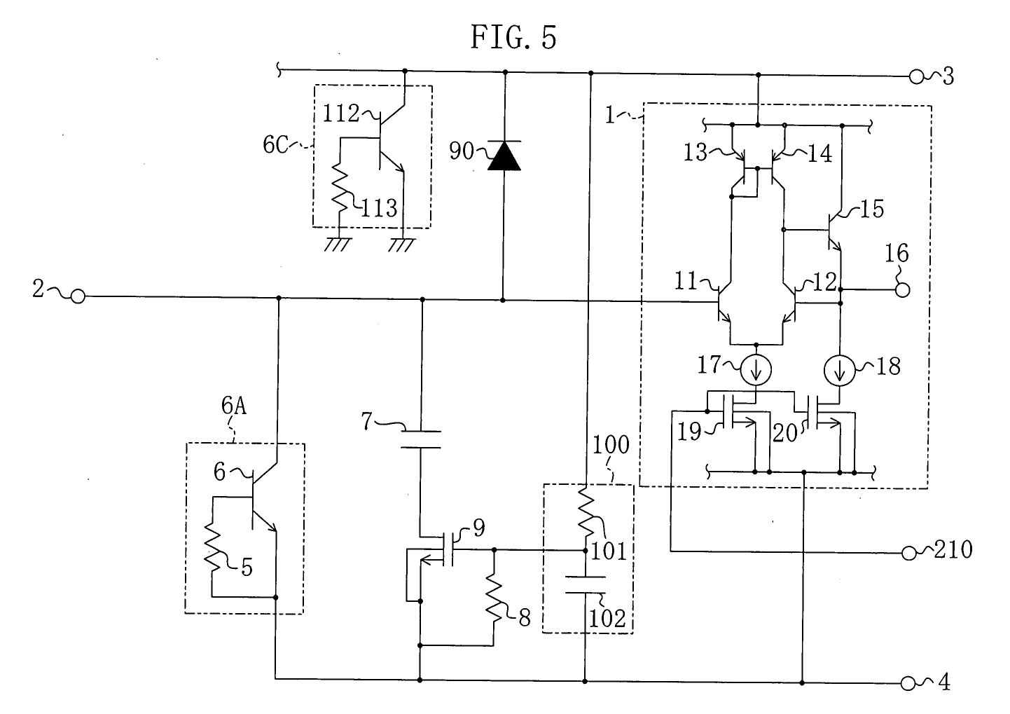

FIG. 5 shows a circuit structure of a semiconductor integrated circuit device according to the second embodiment. The description of the components shown in FIG. 5 which are the same as shown in FIG. 1 will be omitted by retaining the same reference numerals.

The semiconductor integrated circuit device according to the second embodiment is different from the semiconductor integrated circuit device according to the first embodiment in that a delay circuit 100 is provided in place of the control circuit 10 shown in FIG. 1.

The delay circuit 100 is a low-pass filter (LPF circuit) comprised of a third resistor 101 connected between the high-potential power source terminal 3 and the gate of the third N-type MOS transistor 9 and a second capacitor 102 connected between the gate of the third N-type MOS transistor 9 and the low-potential power source terminal 4.

In addition, the semiconductor integrated circuit device according to the present embodiment has a second surge protection circuit 6C comprised of: a diode element 90 having an anode connected to the first external terminal 2 and a cathode connected to the high-potential power source terminal 3; a fifth NPN-type transistor 112 having a collector connected to the high-potential power source terminal 3 and an emitter connected to the ground; and a fourth resistor 113 having one terminal connected to the base of the fifth NPN-type transistor 112 and the other terminal connected to the ground.

The internal circuit 1 has the operation thereof controlled by the control signal from the control terminal 210 connected to the gate of each of the first and second N-type MOS transistors 19 and 20.

Since the semiconductor integrated circuit device according to the second embodiment has the delay circuit 100 provided between the high-potential power source terminal 3 and the gate of the third N-type MOS transistor 9, when a positive surge voltage is applied to the first external terminal 2, a delay occurs between a rise in the potential at the high-potential power source terminal 3 via the diode element 90 and a shift to the ON state in the third N-type MOS transistor 9.

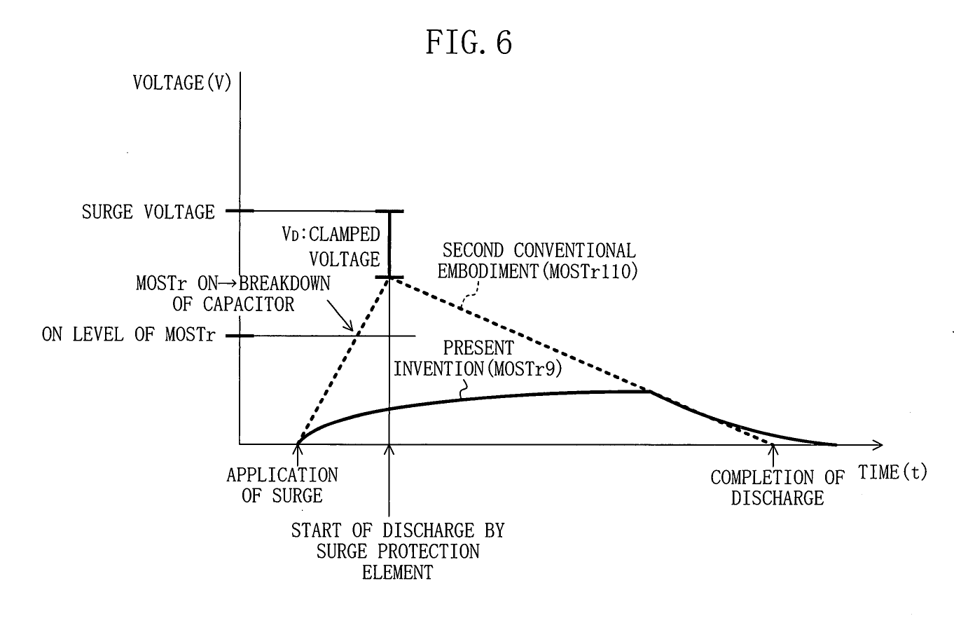

FIG. 6 shows the relationship between the gate voltage of the third N-type MOS transistor 9 and an elapsed time during the application of a surge voltage in the second embodiment of the present invention. In FIG. 6, the gate voltage of the third N-type MOS transistor 9 according to the second embodiment is indicated by the solid line, while the time-varying gate voltage of the MOS transistor 110 according to the second conventional embodiment is indicated by the broken line for comparison. As shown in FIG. 6, in the semiconductor integrated circuit device according to the second embodiment, the discharge of the surge voltage applied to the first external terminal 2 via the diode element 90 and the second surge protection circuit 6C is completed before the potential at the high-potential power source terminal 3 that has risen exceeds the ON level of the N-type MOS transistor 9. As a result, the capacitor 7 can be prevented from breakdown due to the surge.

By contrast, in the semiconductor integrated circuit device according to the second conventional embodiment, the voltage clamped by the diode element 90 has already exceeded the ON level of the MOS transistor 110.

### Variation of Embodiment 2

A variation of the second embodiment of the present invention will be described herein below with reference to the drawings.

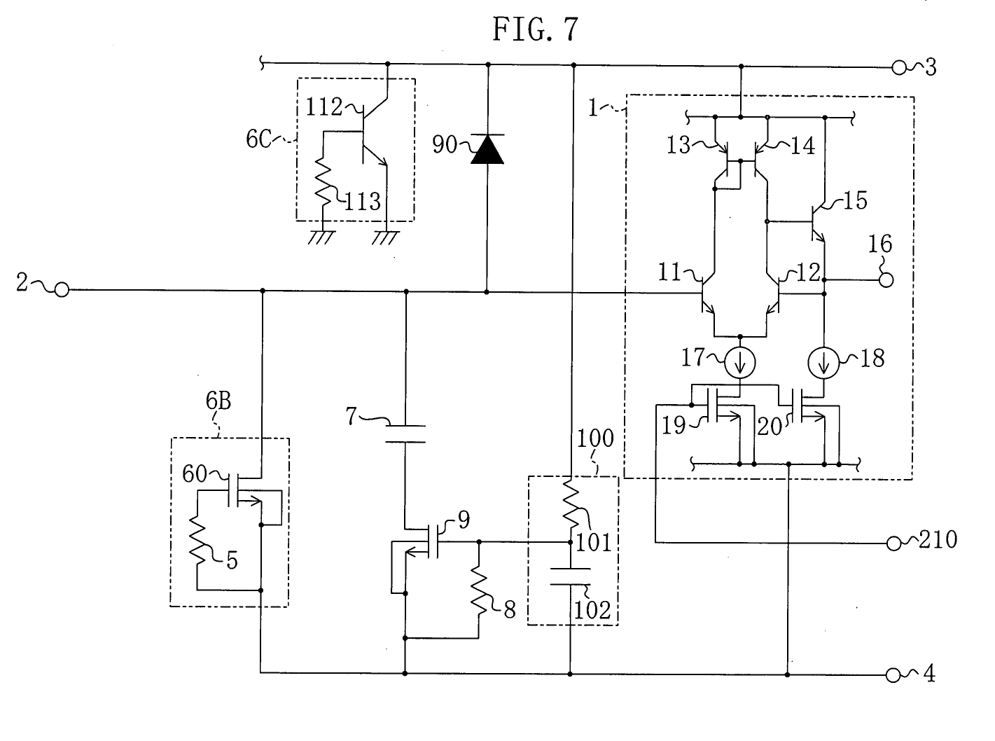

FIG. 7 shows a circuit structure of a semiconductor integrated circuit device according to the variation of the second embodiment. The description of the components shown in FIG. 7 which are the same as shown in FIG. 5 will be omitted by retaining the same reference numerals.

As shown in FIG. 7, the present variation is different from the second embodiment in that the surge protection circuit 6B has the fourth N-type MOS transistor 60 in place of the fourth NPN-type transistor 6. Specifically, the surge protection circuit 6B is comprised of the fourth N-type MOS transistor 60 having the drain connected to the first external terminal 2 and the source connected to the low-potential power source terminal 4 and the first resistor 5 having one terminal connected to the gate of the fourth N-type MOS transistor and the other terminal connected to the source thereof in the same manner as in the variation of the first embodiment.

In the present variation also, the surge protection circuit 6B has the MOS transistor in place of the bipolar transistor so that the breakdown voltage (BV_{M}) of the third N-type MOS transistor 9 is equal to the breakdown voltage (BV_{T}) of the surge protection circuit 6B and the relationship represented by the numerical expression (1) shown above is necessarily satisfied. This allows reliable protection of the capacitor 7 for improving the RF characteristics from breakdown due to the surge.

Thus, in the semiconductor integrated circuit device according to the present invention, the surge protection circuit 6A or 6B is provided between the first external terminal 2 and the low-potential power source terminal 4 in the internal circuit 1. In addition, the capacitor 7 as a noise filter for improving the RF characteristics and the MOS transistor 9 for improving the breakdown voltage of the capacitor 7 and protecting it are also provided in parallel with the surge protection circuits 6A and 6B. Moreover, the control circuit 10 or the delay circuit 100 for controlling the MOS transistor 9 is provided.

In the structure, when a surge voltage is applied to the first external terminal 2, even though the breakdown voltage of the surge protection circuit 6A connected between the first external terminal 2 and the low-potential power source terminal 4 or the like becomes higher than the breakdown voltage of the capacitor 7 to be protected due to variations in fabrication, it is possible to prevent the MOS transistor 9 from being turned ON by using the control circuit 10 or the delay circuit 100. As a result, the breakdown of the capacitor 7 due to the surge voltage can be prevented with the total sum of the breakdown voltage of the capacitor 7 to be protected and the breakdown voltage of the MOS transistor 9 in the OFF state.

When the semiconductor integrated circuit device according to the first embodiment is in a normal operating state, the MOS transistor 9 is turned ON by the control circuit 10 controlled by the second external terminal 21 so that the input impedance of the MOS transistor 9 lowers to allow improvements in the RF characteristics of the semiconductor integrated circuit device.

Thus, the semiconductor integrated circuit device according to the present invention prevents the breakdown of the internal circuit thereof due to a surge voltage, while allowing the protection of the capacitor for improving the characteristics of the semiconductor integrated circuit device from breakdown due to the surge without being affected by variations in the breakdown voltage of the surge protection circuit. Hence, the semiconductor integrated circuit device according to the present invention is useful as a semiconductor integrated circuit device composing electronic equipment which is prone to the influence of RF (Radio Frequency) noise or the like.

What is claimed is:

1. A semiconductor integrated circuit device comprising:
an internal circuit connected to each of an external terminal, a high-potential power source terminal, and a low-potential power source terminal;
a surge protection circuit connected between the external terminal and the low-potential power source terminal to protect the internal circuit from a surge voltage applied to the external terminal;
a capacitor having one terminal connected to the external terminal;
a transistor connected between the other terminal of the capacitor and the low-potential power source terminal; and
a control circuit which brings the internal circuit into a stopped state and does not activate the transistor when the surge voltage is applied to the external terminal.

2. The semiconductor integrated circuit device of claim 1, wherein the surge protection circuit comprises:
a bipolar transistor having a collector connected to the external terminal and an emitter connected to the low-potential power source terminal; and
a first resistor having one terminal connected to a base of the bipolar transistor and the other terminal connected to the emitter.

3. The semiconductor integrated circuit device of claim 1, wherein the surge protection circuit comprises:
a first field-effect transistor having a drain connected to the external terminal and a source connected to the low-potential power source terminal; and
a first resistor having one terminal connected to a gate of the first field-effect transistor and the other terminal connected to the source.

4. The semiconductor integrated circuit device of claim 1, wherein the transistor is a second field-effect transistor having a drain connected to the other terminal of the capacitor, a source connected to the low-potential power source terminal, and a gate connected to the low-potential power source terminal with a second resistor interposed therebetween.

5. The semiconductor integrated circuit device of claim 4, wherein the control circuit is connected to the gate of the second field-effect transistor.

6. A semiconductor integrated circuit device comprising:
an internal circuit connected to each of an external terminal, a high-potential power source terminal, and a low-potential power source terminal;
a surge protection circuit connected between the external terminal and the low-potential power source terminal to protect the internal circuit from a surge voltage applied to the external terminal;
a first capacitor having one terminal connected to the external terminal;
a transistor connected between the other terminal of the first capacitor and the low-potential power source terminal; and
a delay circuit which activates, when the surge voltage is applied to the external terminal, the transistor after a specified time has elapsed from the application of the surge voltage.

7. The semiconductor integrated circuit device of claim 6, wherein the surge protection circuit comprises:
a bipolar transistor having a collector connected to the external terminal and an emitter connected to the low-potential power source terminal; and
a first resistor having one terminal connected to a base of the bipolar transistor and the other terminal connected to the emitter.

8. The semiconductor integrated circuit device of claim 6, wherein the surge protection circuit comprises:
a first field-effect transistor having a drain connected to the external terminal and a source connected to the low-potential power source terminal; and
a first resistor having one terminal connected to a gate of the first field-effect transistor and the other terminal connected to the source.

9. The semiconductor integrated circuit device of claim 6, wherein the transistor is a second field-effect transistor having a drain connected to the other terminal of the first capacitor, a source connected to the low-potential power source terminal, and a gate connected to the low-potential power source terminal with a second resistor interposed therebetween.

10. The semiconductor integrated circuit device of claim 9, wherein the delay circuit is a low-pass filter including a third resistor connected between the high-potential power source terminal and the gate of the second field-effect transistor and a second capacitor connected between the gate of the second field-effect transistor and the low-potential power source terminal.
